(19) United States
(12) Patent Application Publication
(10) Pub. No.: US 2026/0063180 A1
(43) Pub. Date: Mar. 5, 2026

(54) ELECTROMECHANICAL BRAKE COMPRISING PRIMARY-SHAPED OR RESHAPED MOTOR HOUSING

(71) Applicant: Robert Bosch GmbH, Stuttgart (DE)

(72) Inventor: Dietmar Kratzer, Hersbruck (DE)

(21) Appl. No.: 19/298,625

(22) Filed: Aug. 13, 2025

(30) Foreign Application Priority Data
Aug. 30, 2024 (DE) 10 2024 208 265.1

(51) Int. Cl. F16D 65/00; B60T 13/74; F16D 65/18; F16D 121/24

(52) U.S. Cl. CPC F16D 65/0068; F16D 65/18; B60T 13/746; F16D 2121/24; F16D 2200/0034; F16D 2250/0007; F16D 2250/0023

(57) ABSTRACT

An electromechanical brake for a motor vehicle. The electromechanical brake includes an electric motor, which rotationally drives a mechanical adjustment unit arranged in a brake caliper housing, so that, for applying a braking force, a brake actuator is displaceable in an axial direction of the brake caliper housing. A motor housing arranged radially on the brake caliper housing accommodates the electric motor, and a control device housing of a control device controlling the electric motor is arranged on the motor housing. The motor housing is formed from the brake caliper housing and the control device housing, and the brake caliper housing is manufactured by a primary-shaping or reshaping step. A motor housing edge formed by the brake caliper housing, between the brake caliper housing and the control device housing, is formed in such a way that a radial height of the motor housing edge increases in the axial direction.

### CROSS REFERENCE

The present application claims the benefit under 35 U.S.C. § 119 of Germany Patent Application No. DE 10 2024 208 265.1 filed on Aug. 30, 2024, which is expressly incorporated herein by reference in its entirety.

### FIELD

The present invention relates to an electromechanical brake for a motor vehicle and to a motor vehicle having such an electromechanical brake.

### BACKGROUND INFORMATION

The service brake is usually a brake that uses brake fluid to press a brake piston together with a brake pad onto a brake disk in order to brake the vehicle. Amid the increasing electrification of constituent units in the motor vehicle, the service brake is also to be formed as an electromechanical brake so that the need for brake fluid and the associated complex valve and line structure can be eliminated. Such an electromechanical brake could also significantly reduce maintenance requirements.

PCT Patent Application No. WO 2023/166434 A1 describes a brake caliper for a disk brake. The brake caliper comprises a brake caliper housing on which a transmission housing is arranged. A control housing, which houses an electric motor and a brake control device that controls the electric motor, is attached to a rear side of the transmission housing.

Germany Patent Application No. DE 10 2009 046 044 B4 describes an electromechanically actuatable disk brake for a motor vehicle. The electromechanically actuatable disk brake comprises a caliper housing, which surrounds a brake disk. The caliper housing has a housing-like recess, in which an electric motor of the brake is arranged. Arranged above the electric motor and the caliper housing is a gear transmission, via which a spindle drive unit arranged in the caliper housing is driven. A circuit carrier of a control unit is provided above the gear transmission, via which control unit the electric motor can be controlled. The circuit carrier and the gear transmission are closed off from the outside by a cover.

The problem addressed by the present invention is that of specifying an electromechanical brake that is easier and more cost-effective to manufacture.

The problem may be solved by an electromechanical brake having certain features of the present invention. Preferred embodiments of the present invention are disclosed herein.

### SUMMARY

The present invention provides an electromechanical brake for a motor vehicle. According to an example embodiment of the present invention, the electromechanical brake comprises an electric motor, which rotationally drives a mechanical adjustment unit arranged in a brake caliper housing, so that, for applying a braking force, a brake actuator is displaceable in an axial direction of the brake caliper housing. A motor housing arranged radially on the brake caliper housing accommodates the electric motor, and a control device housing of a control device controlling the electric motor is arranged on the motor housing.

The motor housing is formed from the brake caliper housing and the control device housing, and the brake caliper housing is manufactured by a primary-shaping or reshaping step. A motor housing edge formed by the brake caliper housing, between the brake caliper housing and the control device housing, is formed in such a way that a radial height of the motor housing edge increases in the axial direction, starting from at least one axial edge side.

The adjustment unit is a unit that converts the rotational movement of the electric motor into a translational movement. By means of this rotational movement, the brake actuator is axially displaceable. The brake actuator comprises a component that, for braking, comes into contact with a brake disk. The axial direction is a direction along which the adjustment unit and the brake caliper housing are aligned. The motor housing accommodates the electric motor, with the electric motor being arranged in a housing separate from the adjustment unit and the control device. The motor housing edge is part of the motor housing that limits the motor housing on the peripheral side.

According to an example embodiment of the present invention, in a primary-shaping or reshaping process, the work material is formed by means of at least two workpiece shaping means. Structures of the work material can thereby usually only be formed in the direction in which the workpiece shaping means are moved relative to each other. For forming a recess opposite to the direction of movement of the two workpiece shaping means, e.g., a recess of the motor housing, a further workpiece shaping means would be necessary, which would significantly increase the production costs. By forming the radially arranged motor housing from the brake caliper housing and the control device housing, the radial housing structure does not have to be formed by the brake caliper housing alone.

According to an example embodiment of the present invention, the motor housing edge increases in the axial direction, starting from at least one axial edge side. Accordingly, at least one of the workpiece shaping means can form an interior of the motor housing and an axial side of the motor housing edge from one axial edge side. This eliminates the need for a further workpiece shaping means, so that the brake caliper housing forms part of the motor housing by means of two workpiece shaping means. The brake caliper housing can thereby be formed simply and economically despite the radially arranged motor housing.

In a preferred example embodiment of the present invention, a height of the motor housing edge increases from both axial edge sides in the radial direction. An interior of the motor housing is thus formed by both workpiece shaping means. Such a design of the motor housing has the advantage that machining work for finishing the motor housing can be further reduced.

In a further preferred example embodiment of the present invention, the brake caliper housing manufactured by the primary-shaping or reshaping step is post-processed by machining in the region of the motor housing. Advantageously, the motor housing is post-processed by machining on the inside. This allows a sufficiently large interior space to be formed for accommodating the electric motor. Post-processing by machining can improve the manufacturing tolerance of the brake caliper housing manufactured by a primary-shaping or reshaping step. In addition, this can reduce the weight of the electromechanical brake on the unsprung wheel, thus increasing driving comfort.

Preferably, the brake caliper housing is formed as a forged part. Manufacturing the brake caliper housing as a forged part results in greater strength than castings of the same or lower weight. In addition, a forged part has excellent mechanical properties. The manufacture of the brake caliper housing by forging is also suitable for mass production.

In an alternative development of the present invention, the brake caliper housing is formed as a die-cast part. The die-casting process can also be used to manufacture complex geometries. In addition, the die-casting process can reduce the manufacturing costs for such a brake caliper housing. The die-casting process also allows for a good surface quality to be achieved, so that the brake caliper housing needs hardly any post-processing.

According to a further advantageous embodiment of the present invention, the brake caliper housing is formed as an extruded part. Forming the brake caliper housing as an extruded part has the advantage that such manufacture is particularly suitable for mass production. In addition, extrusion achieves optimal material utilization and strengthens the workpiece.

In a further advantageous embodiment of the present invention, the control device housing is formed from a plastics material.

Forming the control device housing from a plastics material has the advantage that it can be easily manufactured by an injection molding process. Such a control device housing makes it easy to adapt the motor housing edge formed by the control device housing to the motor housing edge of the brake caliper housing. In addition, a housing formed in this way has a low weight and low manufacturing costs.

According to an expedient embodiment of the present invention, a seal between the control device housing and the brake caliper housing is formed by the control device housing. Such a seal protects an interior of the motor housing against dirt and moisture. The seal is provided by the control device housing.

This has the advantage that the seal can be provided more easily and economically in the control device housing, which is advantageously formed from plastics, than in the brake caliper housing formed from metal. This eliminates the need for an additional work step to form a groove for a seal in the brake caliper housing.

The present invention additionally specifies a motor vehicle having an electromechanical brake according to the present invention. With such a motor vehicle, the advantages and properties described above are achieved.

Exemplary embodiments of the present invention are illustrated in the figures and explained in more detail in the following description.

### BRIEF DESCRIPTION OF THE DRAWINGS

FIG. 1 is a sectional view of an electromechanical brake according to an exemplary embodiment of the present invention.

FIG. 2 is a side view of the brake caliper housing, according to an example embodiment of the present invention.

FIG. 3 is a perspective view of the brake caliper housing according to FIG. 2.

FIG. 4 is a view of the brake caliper housing according to FIG. 3 after post-processing by machining.

FIG. 5 is a perspective view of the brake caliper housing according to a further exemplary embodiment of the present invention.

FIG. 6 is a side view of the brake caliper housing according to a further exemplary embodiment of the present invention.

FIG. 7 is a perspective view of the brake caliper housing according to FIG. 6.

FIG. 8 is a perspective view of the brake caliper housing according to FIG. 7 after post-processing by machining.

### DETAILED DESCRIPTION OF EXAMPLE EMBODIMENTS

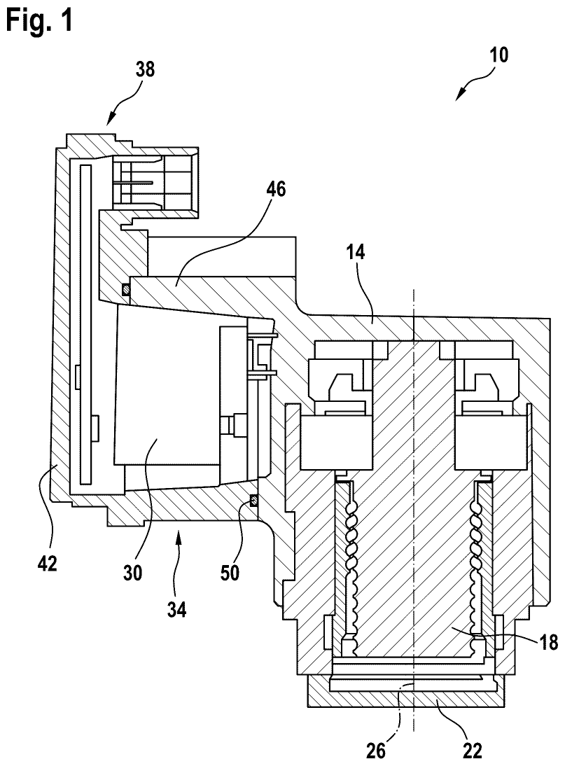

FIG. 1 is a sectional view of an electromechanical brake 10 according to an exemplary embodiment of the present invention. The electromechanical brake 10 comprises a brake caliper housing 14, in which an adjustment unit 18 is arranged. In the exemplary embodiment shown, the brake caliper housing 14 is designed in two parts, with both parts being firmly connected to one another. However, in an exemplary embodiment not shown, the brake caliper housing 14 can also be formed in one part. In the exemplary embodiment shown, the adjustment unit 18 is designed as a spindle drive unit, at the end of which a brake actuator 22 is arranged. This brake actuator 22 is displaceable in an axial direction 26 of the brake caliper housing. The adjustment unit 18 is driven by an electric motor 30, which is provided radially to the brake caliper housing 14.

The electric motor 30 is arranged in a motor housing 34, which is also provided radially to the adjustment unit 18. A control device 38, via which the electric motor 30 can be controlled, is positioned downstream of the motor housing 34. The control device 38 is arranged in a control device housing 42 formed from plastics. According to the present invention, the motor housing 34 is formed from part of the brake caliper housing 14 and part of the control device housing 42. Brake caliper housing 14 and control device housing 42 both form part of a motor housing edge 46. A seal 50 is positioned between the motor housing edge 46 formed by the brake caliper housing 14 and the motor housing edge 46 formed by the control device housing 42, which seal is provided in the motor housing edge 46 formed by the control device housing 42. This protects the electric motor 30 against external influences such as dirt or moisture.

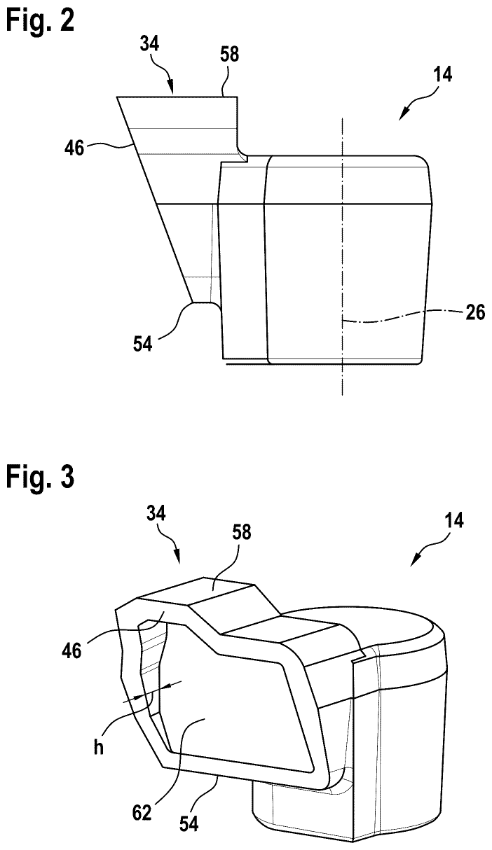

FIG. 2 is a side view of the brake caliper housing 14. The brake caliper housing 14 shown in this figure corresponds to the exemplary embodiment shown in FIG. 1. A height h of the motor housing edge 46 formed by the brake caliper housing 14 increases from a first axial edge side 54 to a second axial edge side 58 of the motor housing 34. A perspective view of the brake caliper housing 14 of FIG. 2 is shown in FIG. 3. It can be seen that, on the first axial edge side 54, the motor housing edge 46 has the same height h as a motor housing bottom 62 formed by the brake caliper housing 14. This makes it possible for a primary-shaping or reshaping tool to manufacture the entire brake caliper housing 14, including the part of the motor housing 34 formed by the brake caliper housing 14, in the axial direction 26. As a result, for forming the motor housing 34, no cross slide is necessary to form a radial structure.

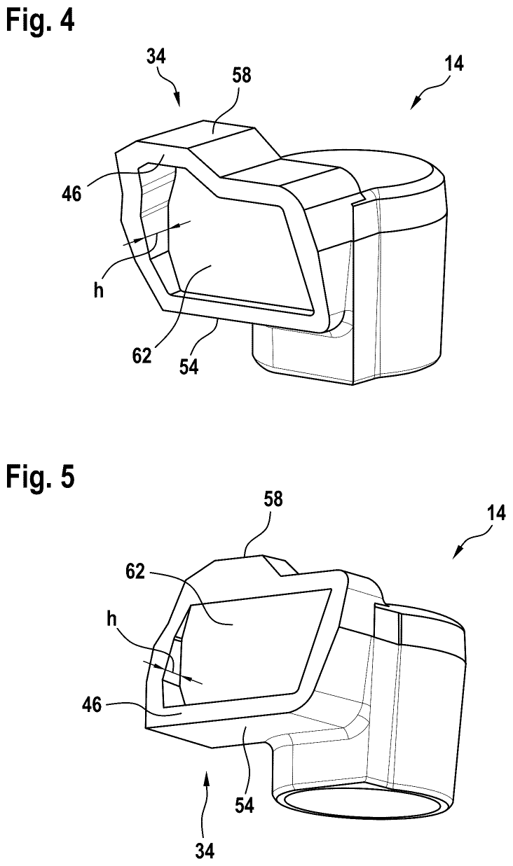

FIG. 4 is a view of the brake caliper housing 14 according to FIG. 3 after post-processing by machining. During the post-processing by machining, a thickness of the motor housing bottom 62 formed by the brake caliper housing 14 was reduced. As a result, a height h for the motor housing edge 46 is also formed on the first axial edge side 54. Post-processing improves manufacturing tolerances. In addition, the weight of the brake caliper housing 14 can be reduced.

A further exemplary embodiment of the present invention is shown in FIG. 5. In contrast to the exemplary embodiment according to FIG. 1-4, in this exemplary embodiment, a height h of the motor housing edge 46 formed by the brake caliper housing 14 increases from the second axial edge side 58 to the first axial edge side 54 of the motor housing 34. Otherwise, this exemplary embodiment corresponds to the above-described exemplary embodiment.

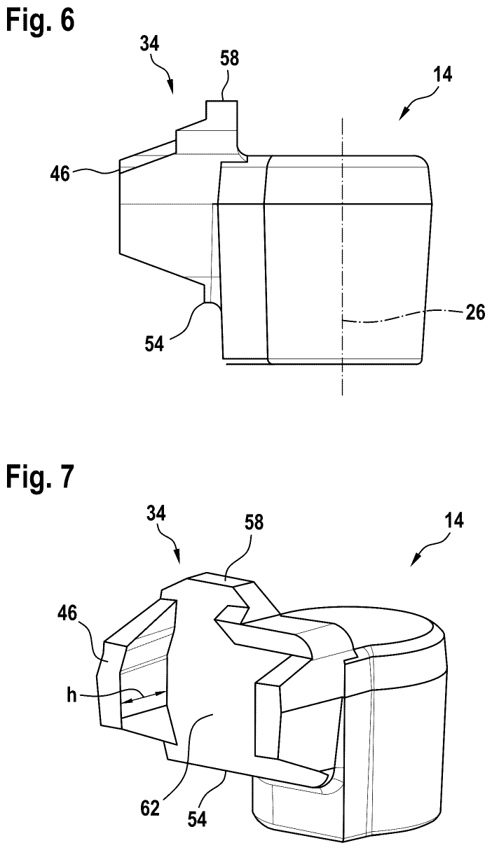

A side view of the brake caliper housing 14 according to a further exemplary embodiment of the present invention is shown in FIG. 6. In this exemplary embodiment, a height h of the motor housing edge 46 formed by the brake caliper housing 14 increases both from the first axial edge side 54 and from the second axial edge side 58 of the motor housing 34. This makes it possible for an interior of the part of the motor housing 34 formed by the brake caliper housing 14 to be formed by primary-shaping or reshaping tools from both axial edge sides 54, 58.

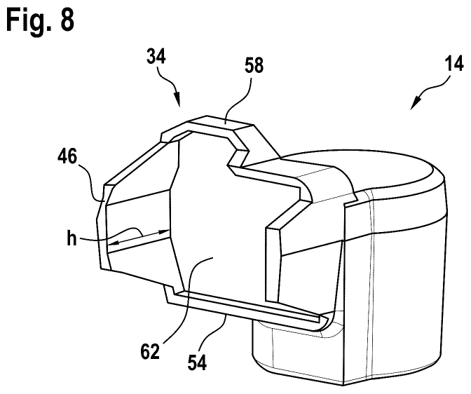

A perspective view of the brake caliper housing 14 shown in FIG. 6 is shown in FIG. 7. This figure shows that the motor housing edge 46 is chamfered from both axial edge sides 54, 58. The two chamfers meet at the maximum height h of the motor housing edge 46. In this exemplary embodiment, post-processing by machining can also take place, as shown in FIG. 8. In contrast to the post-processing by machining of FIG. 4, in this brake caliper housing 14, an inner side of the motor housing edge 46 has also been machined. This increases an interior space of the motor housing 34 and also reduces the weight of the brake caliper housing 14.

What is claimed is:

1. An electromechanical brake for a motor vehicle, comprising:
an electric motor, which rotationally drives a mechanical adjustment unit arranged in a brake caliper housing, so that, for applying a braking force, a brake actuator is displaceable in an axial direction of the brake caliper housing, wherein a motor housing arranged radially on the brake caliper housing accommodates the electric motor, and a control device housing of a control device controlling the electric motor is arranged on the motor housing;
wherein the motor housing is formed from the brake caliper housing and the control device housing, and the brake caliper housing is manufactured by a primary-shaping or reshaping step, wherein a motor housing edge formed by the brake caliper housing, between the brake caliper housing and the control device housing, is formed in such a way that a radial height of the motor housing edge increases in the axial direction, starting from at least one axial edge side.

2. The electromechanical brake according to claim 1, wherein the height of the motor housing edge increases from both axial edge sides in a radial direction.

3. The electromechanical brake according to claim 1, wherein the brake caliper housing manufactured by the primary-shaping or reshaping step is machined in a region of the motor housing.

4. The electromechanical brake according to claim 1, wherein the brake caliper housing is formed as a forged part.

5. The electromechanical brake according to claim 1, wherein the brake caliper housing is a die-cast part.

6. The electromechanical brake according to claim 1, wherein the brake caliper housing is formed as an extruded part.

7. The electromechanical brake according to claim 1, wherein the control device housing is formed from a plastics material.

8. The electromechanical brake according to claim 1, wherein a seal between the control device housing and the brake caliper housing is formed by the control device housing.

9. A motor vehicle, comprising:
an electromechanical brake, including:
an electric motor, which rotationally drives a mechanical adjustment unit arranged in a brake caliper housing, so that, for applying a braking force, a brake actuator is displaceable in an axial direction of the brake caliper housing, wherein a motor housing arranged radially on the brake caliper housing accommodates the electric motor, and a control device housing of a control device controlling the electric motor is arranged on the motor housing,
wherein the motor housing is formed from the brake caliper housing and the control device housing, and the brake caliper housing is manufactured by a primary-shaping or reshaping step, wherein a motor housing edge formed by the brake caliper housing, between the brake caliper housing and the control device housing, is formed in such a way that a radial height of the motor housing edge increases in the axial direction, starting from at least one axial edge side.
